(19) United States
(12) Patent Application Publication
(10) Pub. No.: US 2009/0129444 A1
(43) Pub. Date: May 21, 2009

(54) Multi-code multicarrier code division multiple access system in frequency-selective fading channels

(76) Inventors: Juinn-Horng Deng, Pingjhen City (TW); Jeng-Kuang Hwang, Jhongli City (TW); Yu-Lun Chiu, Kaohsiung City (TW); Rih-Lung Chung, Longtan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/984,563

(22) Filed: Nov. 20, 2007

(51) Int. Cl. H04B 1/707

(52) U.S. Cl. 375/146; 375/E01.002

(57) ABSTRACT

The present invention relates to a multi-code multicarrier code division multiple access system in frequency-selective fading channels. According to the present invention, the transmitting device thereof uses the mapping/spectrum-spreading units to receive the plurality of substreams, map and spread the plurality of substreams, and produce a plurality of biorthogonal keying data items. The plurality of repetition units receives the plurality of biorthogonal keying data items, respectively, repeats the plurality of biorthogonal keying data items, and produces the plurality of repeated data item. The shifting units shift the plurality of repeated data items, respectively, and produce a plurality of shifted data items. The shifted data items are orthogonal to each other. Thereby, the peak-to-average-power-ratio (PAPR) is lowered.

### FIELD OF THE INVENTION

The present invention relates to a multicarrier code division multiple access system, and particularly to a multi-code multicarrier code division multiple access system in frequency-selective fading channels.

### BACKGROUND OF THE INVENTION

Because the transmission content in modern network and communication has developed from transmitting text and voice to transmitting various multimedia data, the demand for wireless network bandwidth has increased significantly. The communication technology of multicarrier code division multiple access (MC-CDMA) combines the communication technologies of multicarrier transmission and code division multiple access (CDMA), and applies spread spectrum technology to orthogonal frequency division multiplexing (OFDM) architecture. The MC-CDMA allows the spread-spectrum codes of an individual client be modulated independently on each carrier, so that channel fading exhibits flat characteristics. In addition, the effect of frequency diversification is provided, and thereby first-order equalizers can be applied for opposing against the intersymbol interference problems.

Nevertheless, the communication technology of MC-CDMA has low spectral efficiency and diversity gain. Besides, when applied to wide bandwidth systems, which means an environment with multiple paths, because of the intersymbol interference (ISI) and loss of orthogonality between substreams, the efficiency of multicarrier transmission is reduced. Thereby, better performance in diversity gain and spectral efficiency cannot be provided. In addition, while transmitting data, for example, OFDM signals, using a general MC-CDMA system, the peak-to-average-power-ratio (PAPR) is higher.

Accordingly, the present invention provides a novel multicarrier code division multiple access system in frequency-selective fading channels, which has a simple transmission circuit, a lower PAPR, and a better spectral efficiency.

### SUMMARY

An objective of the present invention is to provide a multi-code multicarrier code division multiple access system in frequency-selective fading channels, which uses a mapping/spectrum-spreading unit to reduce the peak-to-average-power-ratio (PAPR).

Another objective of the present invention is to provide a multi-code multicarrier code division multiple access system in frequency-selective fading channels, which has a simple circuit architecture, and thus the cost is reduced.

Still another objective of the present invention is to provide a multi-code multicarrier code division multiple access system in frequency-selective fading channels, which uses the multi-code technology to achieve a better spectral efficiency.

The multi-code multicarrier code division multiple access system in frequency-selective fading channels according to the present invention comprises a transmitting device and a receiving device. The transmitting device comprises a demultiplexer, a plurality of mapping/spectrum-spreading units, a plurality of repetition units, a plurality of shifting units, an adder, an inverse transform according to unit, and a radio-frequency unit. The demultiplexer receives an input signal, produces a plurality of substreams, and transmits to the plurality of mapping/spectrum-spreading units. The mapping/spectrum-spreading units map and spread the plurality of substreams, and produce a plurality of biorthogonal keying data items. The plurality of repetition units receives the plurality of biorthogonal keying data items, respectively, repeats the plurality of biorthogonal keying data items, and transmits the plurality of repeated data items to the plurality of shifting units. The shifting units shift the plurality of repeated data items, and produce a plurality of shifted data items. The shifted data items are orthogonal to each other. The adder receives the plurality of shifted data items produced by the plurality of shifting units, sums up the plurality of shifted data items, and produces summation data. The inverse transform unit receives the summation data, and transforms the summation data to time-domain data. The radio-frequency unit receives the time-domain data, and produces and transmits a radio-frequency signal.

Besides, the receiving device comprises a radio-frequency unit, a transform unit, a plurality of phase-shift units, a plurality of spectrum-despreading units, a plurality of demapping/judging units, and a multiplexer. The radio-frequency unit receives a radio-frequency signal, produces received data, and transmits to the transform unit. The transform unit transforms the received data to frequency-domain data. The plurality of phase-shift units receives the frequency-domain data, respectively, phase-shifts the frequency-domain data, produces a plurality of phase-shifted data items, and transmits to the plurality of spectrum-despreading units. The plurality of spectrum-despreading units despreads the plurality of phase-shifted data items, and produces a plurality of despread data items. The plurality of demapping/judging units receives the plurality of despread data items, respectively, demaps the plurality of despread data items, judges the demapped and despread data items, and produces a plurality of judged data items. The multiplexer receives the plurality of judged data items, and produces output data.

### BRIEF DESCRIPTION OF THE DRAWINGS

FIG. 1 shows a block diagram of the transmitting device according to a preferred embodiment of the present invention;

FIG. 2 shows a detailed block diagram of the mapping/spectrum-spreading unit according to a preferred embodiment of the present invention; and

FIG. 3 shows a block diagram of the receiving device according to a preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

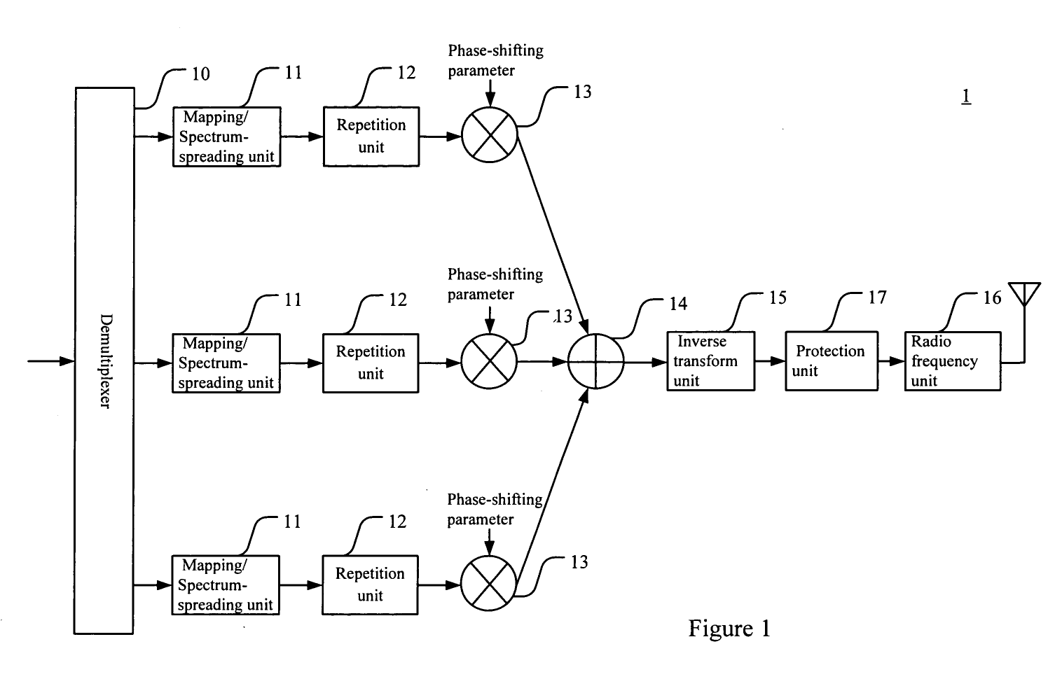

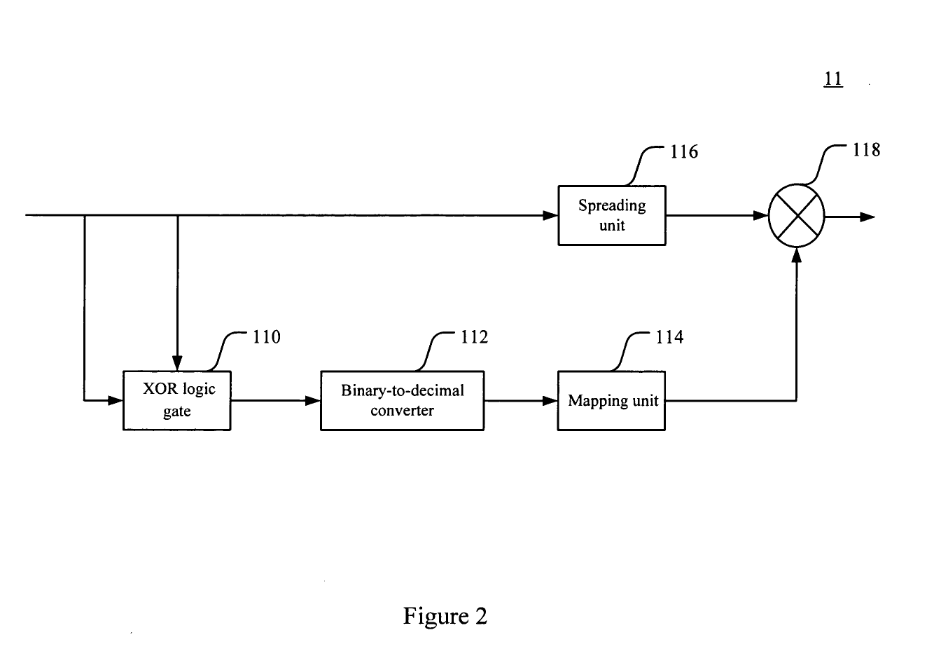

FIG. 1 shows a block diagram of the transmitting device according to a preferred embodiment of the present invention. As shown in the figure, the multi-code multicarrier code division multiple access system in frequency-selective fading channels according to the present invention comprises a transmitting device 1 and a receiving device 2. The transmitting device 1 comprises a demultiplexer 10, a plurality of mapping/spectrum-spreading units 11, a plurality of repetition units 12, a plurality of shifting units 13, an adder 14, an inverse transform unit 15, and a radio-frequency unit 16. The demultiplexer 10 receives input data, and produces a plurality of substreams. The plurality of mapping/spectrum-spreading units 11 receives, respectively, the substreams, which are \tilde{S}ᵢ^{(p)}=[S_{i,0}^{(p)} . . . S_{i,R-1}^{(p)}]^{T}, where p represents the p-th substream, and R represents the number of bits of the substream. FIG. 2 shows a detailed block diagram of the mapping/spectrum-spreading unit according to a preferred embodiment of the present invention. As shown in the figure, the mapping/spectrum-spreading unit 11 includes an XOR logic gate 110, a binary-to-decimal converter 112, a mapping unit 114, a spectrum-spreading unit 116, and a multiplier 118. The XOR logic gate 110 receives the substreams, performs logic operations on the two least significant bits of the substreams and the rest of the substreams, and produces logic data. The binary-to-decimal converter 112 receives the logic data, and converts the logic data to decimal data. The mapping unit 114 receives the decimal data and a Chu sequence, maps the decimal data, and produces mapped data. Namely, N orthogonal codes are used to map R-bit substreams. For example, R=log₂ M, M=N, the spread-spectrum code with N=8 is {C₍₀₎, C₍₁₎, . . . , C₍₇₎}. Thereby, map the substream \tilde{S}ᵢ^{(p)} and the spread-spectrum code Cᵢ^{(p)} as below:

$${C}_{i}^{( p )} = \{ \begin{matrix}{C}_{( 0 )} & if & {\tilde{S}}_{i}^{( p )} = {}_{}^{′}{000}{}_{}^{′} ; {C}_{( 4 )} & if & {\tilde{S}}_{i}^{( p )} = {}_{}^{′}{111}{}_{}^{′} \\ {C}_{( 1 )} & if & {\tilde{S}}_{i}^{( p )} = {}_{}^{′}{001}{}_{}^{′} ; {C}_{( 5 )} & if & {\tilde{S}}_{i}^{( p )} = {}_{}^{′}{110}{}_{}^{′} \\ {C}_{( 2 )} & if & {\tilde{S}}_{i}^{( p )} = {}_{}^{′}{010}{}_{}^{′} ; {C}_{( 6 )} & if & {\tilde{S}}_{i}^{( p )} = {}_{}^{′}{101}{}_{}^{′} \\ {C}_{( 3 )} & if & {\tilde{S}}_{i}^{( p )} = {}_{}^{′}{011}{}_{}^{′} ; {C}_{( 7 )} & if & {\tilde{S}}_{i}^{( p )} = {}_{}^{′}{100}{}_{}^{′}\end{matrix}$$

Afterwards, an N-th order multi-phase Chu sequence C₍₀₎=[C₀, C₁, . . . , C_{N-1}]^{T} can be chosen. The location in C₍₀₎ can be known by Cₙ=e^{jπn}^{²}^{q/N}, 0≦n≦N−1, wherein q and N are correlated. Then, the mapping unit 114 can shift C₍₀₎ cyclically by mth locations and produce C₍ₘ₎. Namely, C₍ₘ₎=[Cₘ, . . . , C_{N-1}, C₀, . . . , Cₘ₋₁]. The Chu sequence in cyclic shifting has the characteristics of auto correlation and cross correlation, that is, [symbol] C₍ₖ₎, C₍ⱼ₎ [symbol] =0 for k≠j, and [symbol] C₍ₖ₎, C₍ₖ₎ [symbol] =N for k=j. In addition, after the Chu sequence for cyclic shifting is inverse Fourier transformed, the peak-to-average-power-ratio (PAPR) is lowered. The mapping unit 114 can combine the cyclically shifted Chu sequence and the decimal data, and produce the mapped data. The spectrum-spreading unit 116 receives the two least significant bits of the substreams, spreads the two least significant bits of the substreams, and produces the spectrum-spread data, namely, dᵢ^{(p)}=S_{i,R}^{(p)}+jS_{i,R+1}^{(p)}. The multiplier 118 receives and multiplies the mapped data by the spectrum-spread data, and produces the biorthogonal keying data, namely, eᵢ^{(p)}=dᵢ^{(p)}Cᵢ^{(p)}, where eᵢ^{(p)} is M-ary biorthogonal keying (MBOK) data, including the substreams Sᵢ^{(p)}=[S_{i,0}^{(p)}, . . . , S_{i,R-1}^{(p)}, S_{i,R}^{(p)}, S_{i,R+1}^{(p)}].

The plurality of repetition units 12 receives the plurality of biorthogonal keying data items, respectively, repeats the plurality of biorthogonal keying data items, and produces the plurality of repeated data items, namely,

$$\begin{matrix}{f}_{i}^{( p )} = {[ {e}_{i}^{( p )} , {e}_{i}^{( p )} , … , {e}_{i}^{( p )} ]}^{T} \\ = {{d}_{i}^{( p )} [ {C}_{i}^{( p )} , {C}_{i}^{( p )} , … , {C}_{i}^{( p )} ]}^{T} \\ = {d}_{i}^{( p )} {\overline{c}}_{i}^{( p )} ;\end{matrix}$$

where the length of fᵢ^{(p)} is PN×1, and c̅ᵢ^{(p)} is the repetition Chu sequence. The plurality of shifting units 13 receives the plurality of repeated data items, respectively, shifts the plurality of repeated data items, and produces the plurality of shifted data items. The shifted data items are orthogonal to each other. The shifting unit 13 is a multiplexer, which multiplies the repeated data item by a phase-shift parameter, namely,

gᵢ^{(p)}=fᵢ^{(p)}□w^{(p)}=dᵢ^{(p)}{ c̅ᵢ^{(p)}□w^{(p)}}=dᵢ^{(p)} c̅ᵢ^{(p)};

where □ represents pairwise multiplication, and w^{(p)} is the p-th order frequency shift operation. That is:

w^{(p)}=[e^{j0}, e^{j2πf}^{ₚ}, . . . , e^{j2πf}^{ₚ}^{(NP-1)}]^{T}

where the frequency shift is performed according to fₚ=p/NP, p=0, 1, . . . , P−1. Besides, the Chu sequence after repetition and frequency shift operations still has orthogonality. That is:

[symbol]

\tilde{c}ᵢ^{(p)}\tilde{c}ⱼ^{(q)} [symbol] =0, for p≠q, i≠j

Thereby, after the operations by the repetition unit 12 and the shifting unit 13, the orthogonality of the plurality substreams is still maintained. In addition, the PAPR is low, and the spectral efficiency is excellent.

The adder 14 receives the plurality of shifted data items produced by the plurality of shifting units 13, sums up the plurality of shifted data, and produces the summation data. The inverse transform unit 15 receives the summation data, and transforms the summation data to time-domain data, namely,

$$\begin{matrix}{{c}^{\tilde{\sim}}}_{i}^{( p )} = IFFT \{ {\tilde{c}}_{i}^{( p )} \} = {Q}^{H} \{ {\tilde{c}}_{i}^{( p )} \} \\ = {[ 0 … 0 , {t}_{i , 0}^{( p )} , 0 … 0 , {t}_{i , 1}^{( p )} , 0 , … ]}^{T}\end{matrix}$$

where Q^{H} is the operation of inverse Fourier transform. The N-point {cᵢ^{(p)}} is inverse Fourier transformed to tᵢ^{(p)}=[t_{i,0}^{(p)}, t_{i,1}^{(p)}, . . . , t_{i,N-1}^{(p)}]^{T}·{tilde over (\tilde{c}ᵢ^{(p)} are various zero-insertion operations and have orthogonality, namely, [symbol] {tilde over (\tilde{c}ᵢ^{(p)}{tilde over (\tilde{c}ⱼ^{(q)} [symbol] =0, for p≠q, i≠j, the signal transmission quality is improved.

The radio-frequency unit receives the time-domain data, and produces and transmits a radio-frequency signal. That is:

$$\begin{matrix}{x}_{i} = IFFT \{ {\sum }_{p = 1}^{P} {d}_{i}^{( p )} {\tilde{c}}_{i}^{( p )} \} \\ = {Q}^{H} \{ {\sum }_{p = 1}^{P} {d}_{i}^{( p )} {\tilde{c}}_{i}^{( p )} \} \\ = {\sum }_{p = 1}^{P} {d}_{i}^{( p )} {{c}^{\tilde{\sim}}}_{i}^{( p )} \\ = {[ {d}_{i}^{( 0 )} {{c}^{\tilde{\sim}}}_{i , 0}^{( 0 )} , {d}_{i}^{( 1 )} {{c}^{\tilde{\sim}}}_{i , 0}^{( 1 )} , … , {d}_{i}^{( P )} {{c}^{\tilde{\sim}}}_{i , 0}^{( P )} , {d}_{i}^{( 0 )} {{c}^{\tilde{\sim}}}_{i , 1}^{( 0 )} , {d}_{i}^{( 1 )} {{c}^{\tilde{\sim}}}_{i , 1}^{( 1 )} , … , {d}_{i}^{( P )} {{c}^{\tilde{\sim}}}_{i , N - 1}^{( P )} , ]}^{T}\end{matrix}$$

Thereby, the transmitting device 1 according to the present invention has as low peak-to-average-power-ratio (PAPR) as the single-carrier code division multiple access (SC-CDMA).

Moreover, the transmitting device 1 according to the present invention further includes a protection unit 17, which receives time-domain data, adds protection data to the time-domain data, transmits to the radio-frequency circuit, and produces and transmits the radio-frequency signal. The protection data is a cyclic prefix.

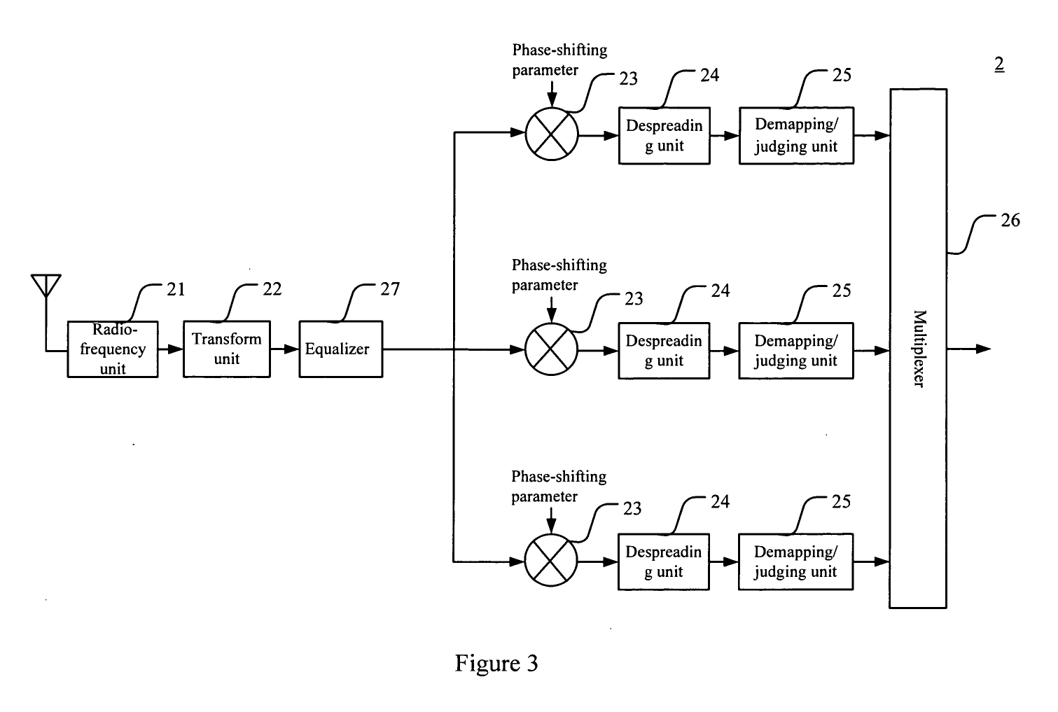

FIG. 3 shows a block diagram of the receiving device according to a preferred embodiment of the present invention. As shown in the figure, the receiving device 2 according to the multi-code multicarrier code division multiple access system in frequency-selective fading channels of the present invention comprises a radio-frequency unit 21, a transform unit 22, a plurality of phase-shift units 23, a plurality of spectrum-despreading units 24, a plurality of demapping/judging units 25, and a multiplexer 26. The radio-frequency unit 21 receives a radio-frequency signal, decodes the protection code added by the protection unit 17 of the transmitting device 1, and produces the received data. The transform unit 22 transforms the received data to frequency-domain data, which is frequency-domain received data. Namely,

$$\begin{matrix}{Y}_{i} = Q {y}_{i} \\ = Λ \{ Q {x}_{i} \} \\ = Λ \{ Q {Q}^{H} \{ {\sum }_{p = 1}^{P} {d}_{i}^{( p )} {\tilde{c}}_{i}^{( p )} \} \} \\ = Λ \{ {\sum }_{p = 1}^{P} {d}_{i}^{( p )} {\tilde{c}}_{i}^{( p )} \}\end{matrix}$$

where Λ is the channel frequency response. Besides, the transform unit 22 is a fast Fourier transform (FFT) unit. An equalizer 27 receives the frequency-domain data, equalizes the frequency-domain data, and produces a equalization signal, namely, zᵢ=qYᵢ, where q is the combined weight matrix. The combined weight matrix is chosen according to minimum mean square error (MMSE) and zero forcing (ZF). By minimum mean square error, it is known that:

$${q ( {ΛΛ}^{H} + {\overline{σ}}_{n}^{2} I )}^{- 1} {Λ}^{H}$$

where σ̅ₙ² is the noise variation of the Fourier transformed white noise. Because Λ and σ̅ₙ²I are diagonal matrices, the weight matrix is still a diagonal matrix. By zero forcing, it is known that:

q=Λ⁻¹

By using zero forcing weight matrix for synthesizing the Fourier transformed frequency data Yᵢ, it is known that the equalization signal is:

$${z}_{i} = {Λ}^{- 1} {Y}_{i} = {\sum }_{p = 1}^{P} {d}_{i}^{( p )} {\tilde{c}}_{i}^{( p )} + {\overline{n}}_{i}$$

where n̅ᵢ=Λ⁻¹{Qnᵢ}. The plurality of phase-shift units 23 receives, respectively, the frequency-domain data, which is the equalization signal output by the equalizer 27, shifts the frequency-domain data, and produces the plurality of phase-shifted data items. The plurality of spectrum-despreading units receives the plurality of phase-shifted data items, respectively, despreads the plurality of phase-shifted data items, and produces the plurality of despread data items. Thereby, the despread data items are given as:

$$\begin{matrix}{\tilde{z}}_{m}^{( p )} ( i ) = {\tilde{c}}_{m}^{{( p )}^{H}} {z}_{i} \\ = {\tilde{c}}_{m}^{{( p )}^{H}} \{ {\sum }_{q = 1}^{P} {d}_{i}^{( q )} {\tilde{c}}_{i}^{( q )} + {\overline{n}}_{i} \} \\ = {d}_{i}^{( p )} {\tilde{c}}_{m}^{{( p )}^{H}} {\tilde{c}}_{i}^{( p )} + {\tilde{n}}_{i}\end{matrix}$$

where ñᵢ=\tilde{c}ₘ^{(p)}^{^{H}} n̅ᵢ and \tilde{c}ₘ^{(p)}^{^{H}}\tilde{c}ᵢ^{(q)}=0, p≠q. In the description above, the phase-shift unit 23 is a multiplexer, which multiplies the repeated data by a phase-shift parameter, and produces the phase-shifted data. The plurality of demapping/judging units 25 receives the plurality of despread data items, respectively, demaps the plurality of despread data items, produces the demapped data, judges the demapped despread data, and produces a plurality of judged data items. The M-ary biorthogonal keying data is cyclic shifted by N times to find the maximum value in the despread data for estimating the demapped data. That is:

[symbol]

=arg max|zₘ^{(p)}(i)|, 0≦m≦N−1

[symbol]

_{MOBK}^{(p)}(i)=[ [symbol] ₒ^{(p)}(i) [symbol] ₁^{(p)}(i) . . . [symbol] _{R-1}^{(p)}(i)]^{T}=dec2bin{ [symbol] }

Finally, according to the maximum value in the despread data, the quadrature phase shift keying (QPSK) symbol data is estimated. Namely,

[symbol]

_{QPSK}^{(p)}(i)=[ [symbol] _{R}^{(p)}(i) [symbol] _{R+1}^{(p)}(i)]=decision{\tilde{z} [symbol] ^{(p)}(i)}

The multiplexer 26 receives the plurality of judged data items, and produces the output data. That is:

[symbol]

^{(p)}(i)=[ [symbol] _{MOBK}^{(p)}(i) [symbol] _{QPSK}^{(p)}(i)]

Thereby, data transmission is accomplished.

To sum up, the multi-code multicarrier code division multiple access system in frequency-selective fading channels according to the present invention uses the mapping/spectrum-spreading units to receive the plurality of substreams, map and spread the plurality of substreams, and produce a plurality of biorthogonal keying data items. The plurality of repetition units receives the plurality of biorthogonal keying data items, respectively, repeats the plurality of biorthogonal keying data items, and produces the plurality of repeated data item. The shifting units shift the plurality of repeated data items, respectively, and produce a plurality of shifted data items. The shifted data items are orthogonal to each other. Thereby, the peak-to-average-power-ratio (PAPR) is lowered. Besides, according to the present invention, the multi-code technology is used for improving spectral efficiency.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A transmitting device for a multi-code multicarrier code division multiple access system in frequency-selective fading channels, comprising:
a demultiplexer, receiving an input signal, and producing a plurality of substreams;
a plurality of mapping/spectrum-spreading units, receiving the plurality of substreams, respectively, mapping and spreading the plurality of substreams, and producing a plurality of biorthogonal keying data items;
a plurality of repetition units, receiving the plurality of biorthogonal keying data items, respectively, repeating the plurality of biorthogonal keying data items, and producing a plurality of repeated data items;
a plurality of shifting units, receiving the plurality of repeated data items, shifting the plurality of repeated data items, and producing a plurality of shifted data items, wherein the shifted data items are orthogonal to each other;
an adder, receiving the plurality of shifted data items produced by the plurality of shifting units, summing up the plurality of shifted data items, and producing summation data;
an inverse transform unit, receiving the summation data, and transforming the summation data to time-domain data; and
a radio-frequency unit, receiving the time-domain data, and producing and transmitting a radio-frequency signal.

2. The transmitting device of claim 1, and further comprising a protection unit, receiving the time-domain data, adding protection data to the time-domain data, and transmitting to the radio-frequency unit for producing and transmitting the radio-frequency signal.

3. The transmitting device of claim 2, wherein the protection data is a cyclic prefix.

4. The transmitting device of claim 1, wherein the plurality of mapping/spectrum-spreading units further comprises:
an XOR logic gate, receiving the plurality of substreams, performing logic operations on the two least significant bits of the substreams and the rest of the substreams, and producing logic data.
a binary-to-decimal converter, receiving the logic data, and converting the logic data to decimal data;
a mapping unit, receiving the decimal data and a Chu sequence, mapping the decimal data, and producing mapped data;
a spreading unit, receiving the two least bits of the substreams, spreading the two least bits of the substreams, and producing spread data; and
a multiplexer, receiving and multiplying the mapped data by the spread data, and producing the plurality of biorthogonal keying data items.

5. The transmitting device of claim 4, wherein the spreading unit adopts quadrature phase shift keying (QPSK).

6. The transmitting device of claim 1, wherein the biorthogonal keying data is M-ary biorthogonal keying (MBOK) data.

7. The transmitting device of claim 1, wherein the shifting unit is a multiplexer, multiplying the repeated data by a phase-shift parameter, and producing the shifted data.

8. The transmitting device of claim 1, wherein the inverse transform unit is an inverse fast Fourier transform (IFFT) unit.

9. A receiving device for a multi-code multicarrier code division multiple access system in frequency-selective fading channels, comprising:
a radio-frequency unit, receiving a radio-frequency signal, and producing received data;
a transform unit, receiving the received data, and transforming the received data to frequency-domain data;
a plurality of phase-shift units, receiving the frequency-domain data, respectively, shifting the frequency-domain data, and producing a plurality of shifted data items;
a plurality of dispreading units, receiving the plurality of shifted data items, respectively, despreading the plurality of shifted data items, and producing a plurality of despread data items;
a plurality of demapping/judging units, receiving the plurality of despread data items, respectively, demapping the plurality of despread data items, judging the demapped despread data items, and producing a plurality of judged data items; and
a multiplexer, receiving the plurality of judged data items, and producing output data.

10. The receiving device of claim 9, and further comprising an equalizer, receiving the frequency-domain data, equalizing the frequency-domain data, and transmitting to the plurality of phase-shift units.

11. The receiving device of claim 9, wherein the phase-shift unit is a multiplexer, multiplying the repeated data by a phase-shift parameter, and producing the shifted data.

12. The transmitting device of claim 9, wherein the inverse transform unit is an inverse fast Fourier transform (IFFT) unit.
